(19) United States
(12) Patent Application Publication
(10) Pub. No.: US 2012/0191407 A1
(43) Pub. Date: Jul. 26, 2012

(54) METHOD AND APPARATUS FOR MANAGING LOCATION OF WARD

(75) Inventors: Hong-soo KIM, Seoul (KR); Sei-kwon KIM, Yongin-si (KR); Jong-ho LEE, Seoul (KR); Eun NAMGUNG, Hwaseong-si (KR)

(73) Assignee: SAMSUNG ELECTRONICS CO., LTD., Suwon-si (KR)

(21) Appl. No.: 13/285,566

(22) Filed: Oct. 31, 2011

(30) Foreign Application Priority Data
Jan. 21, 2011 (KR) 10-2011-0006487

(51) Int. Cl. G06F 19/00

(52) U.S. Cl. 702/150

(57) ABSTRACT

A method and apparatus for managing a location of a ward, the method including: determining a ward location updating period based on a current location of the ward within a safety zone; and if the determined location updating period is about to elapse, transmitting the current location of the ward at a time when the updating period elapses.

### CROSS-REFERENCE TO RELATED PATENT APPLICATION

This application claims priority from Korean Patent Application No. 10-2011-0006487, filed on Jan. 21, 2011 in the Korean Intellectual Property Office, the disclosure of which is incorporated herein in its entirety by reference.

### BACKGROUND

1. Field

Methods and apparatuses consistent with exemplary embodiments relate to managing a location of a ward by using a communications device.

2. Description of the Related Art

As various wireless networks emerge, the coverage of wireless networks increases, the cost of communications modules decreases, and the variety of sensor technologies increases. Additionally, machine-to-machine (M2M) communications are being developed and emerging. Also, as the existing mobile phone market is saturated with mobile communications companies, costs for voice communications have decreased, but the demand for data has increased, and new services for using increased data transmission capacity have increased requiring the development of a next generation network. In particular, M2M technologies have been drawing attention.

Efficient M2M technologies, which are capable of reducing costs for managing the location of a ward, such as an elderly person who lives alone, a disabled person, a child, a patient, or the like, and involve the use of a communications device so as to manage the ward, are required.

### SUMMARY

One or more exemplary embodiments, provide a method and apparatus for managing a location of a ward, and in particular, a method and apparatus which may manage the location of the ward efficiently and reduce costs for managing the location of the ward.

According to an aspect of an exemplary embodiment, there is provided a method of managing a location of a ward, the method including: determining a location updating period based on the location of the ward within a safety zone; and transmitting current location or current location information of the ward when the determined location updating period elapses.

The determining of the location updating period may include calculating a shortest distance from the current location of the ward to a boundary of the safety zone and determining the time it takes for the ward to reach or to arrive at the boundary of the safety zone by using the calculated shortest distance and a movement speed of the ward, as the location updating period.

The method may further include setting the safety zone.

The setting of the safety zone may include setting the safety zone based on an address or setting the safety zone by using an address and a movement radius.

According to another aspect of an exemplary embodiment, there is provided a method of managing a location of a ward, the method including: receiving the location of the ward from a ward communications device at a location updating period determined based on the location of the ward within a safety zone; and determining a current location of the ward with respect to the safety zone and transmitting the current location or current location information of the ward to a guardian communications device according to the determination.

The transmitting of the current location of the ward may include, if the current location of the ward is outside the safety zone, transmitting the current location of the ward to the guardian communications device and if the current location of the ward is not outside the safety zone, not transmitting the current location of the ward to the guardian communications device.

The method may further include receiving information for setting the safety zone from the guardian communications device or the ward communications device.

According to another aspect of an exemplary embodiment, there is provided an apparatus for managing a location of a ward, the apparatus including: a location information management unit determining a location updating period based on the location of the ward within a safety zone and if the determined location updating period is about to elapse, checking a current location of the ward when the determined location updating period elapses; and a communications unit transmitting the current location or current location information of the ward.

The location information management unit may calculate a shortest distance from the current location of the ward to a boundary of the safety zone and determine the time it takes for the ward to arrive at the boundary of the safety zone by using the calculated shortest distance and a movement speed of the ward, as the location updating period.

According to another aspect of an exemplary embodiment, there is provided an apparatus for managing a location of a ward, the apparatus including: a communications unit receiving the location of the ward from a ward communications device at a location updating period determined based on the location of the ward within a safety zone; and a location information management unit determining a current location of the ward with respect to the safety zone and determining whether the current location of the ward is transmitted to a guardian communications device.

The location information management unit, if the current location of the ward is outside the safety zone, may determine that the current location of the ward is transmitted to the guardian communications device and if the current location of the ward is not outside the safety zone, may determine that the current location of the ward is not transmitted to the guardian communications device.

The communications unit may receive information for setting the safety zone from the guardian communications device or the ward communications device.

### BRIEF DESCRIPTION OF THE DRAWINGS

The above and/or other features and advantages of the present disclosure will become more apparent by describing in detail exemplary embodiments thereof with reference to the attached drawings in which:

FIG. 1 schematically illustrates an apparatus for managing a location of a ward according to an embodiment;

FIG. 2A is a schematic block diagram of a ward communications device illustrated in FIG. 1;

FIG. 2B is a schematic block diagram of a guardian communications device illustrated in FIG. 1;

FIG. 3 is a schematic block diagram of a service server illustrated in FIG. 1;

FIG. 4 is a diagram for explaining a method of determining a period for updating a location of a ward, according to an embodiment;

FIG. 5 is a flowchart illustrating an operation of setting a safety zone, according to an embodiment;

FIG. 6A illustrates an example of a limited movement pattern when the safety zone is set, and FIG. 6B illustrates an example of a dynamic movement pattern when the safety zone is set;

FIG. 7 is a flowchart illustrating a method of managing a location of a ward by using a ward communications device, according to an embodiment;

FIG. 8 is a flowchart illustrating a method of managing a location of a ward by using a service server, according to another embodiment;

FIG. 9 illustrates an example of an operation of managing a location of a ward between the ward communications device and the service server; and

FIG. 10 illustrates an example of an operation of managing a location of a ward between the ward communications device, the service server, the guardian communications device, and a home gateway.

### DETAILED DESCRIPTION

Certain exemplary embodiments will now be described more fully with reference to the accompanying drawings.

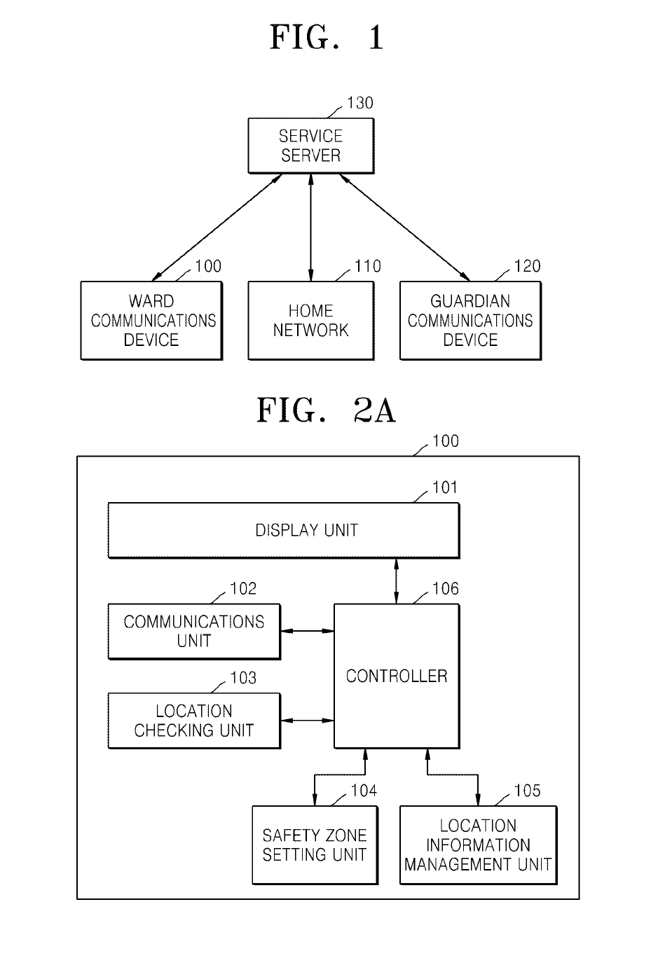

FIG. 1 schematically illustrates an apparatus for managing a location of a ward according to an embodiment.

Referring to FIG. 1, the apparatus for managing the location of the ward includes a ward communications device 100, a home network 110, a guardian communications device 120, and a service server 130.

The ward communications device 100 is a communications device carried by a ward. The ward is usually a child or an elderly person, but is not limited to the child or the elderly person, and can be any person. The ward communications device 100 may be any form of mobile device which has communication function and location identification function. The communication function is, for example, a 3rd Generation (3G) specification and the location identification function is, for example, a global positioning system (GPS). The ward communications device 100 determines a ward location updating period by using a distance from the location of the ward to a boundary of a set safety zone and transmits the location of the ward to the service server 130 at a time according to the determined ward location updating period. Obviously, the ward communications device 100 may transmit information about the location of the ward directly to the guardian communications device 120. In addition, the ward communications device 100 may set the safety zone and may transmit the safety zone to the service server 130.

The home network 110 includes a home gateway device installed in a home that may receive the information about the location of the ward from the service server 130 or the ward communications device 100, and an in-home device connected to the home gateway device.

A home network system includes home appliances including a home network gateway that can be connected to an external communications network and client devices connected to the home network gateway. The home appliances may be a printer, a television (TV), a refrigerator, an air conditioner, a survey camera, a facsimile machine, an illumination device, a digital versatile disc (DVD), a gate, a telephone, a washing machine, and the like, which are connected to a home network and can be controlled or in which data transmission and reception can be performed. The home network gateway may be implemented in the form of an electronic frame, a personal computer (PC), or the like. The home network gateway itself may operate as a home appliance and may transmit status information to an external mobile terminal, or an operation of the home network gateway may be controlled. The external communications network may be a general mobile communications network, a 3G network, or a wireless Internet network.

The guardian communications device 120 receives the information about the location of the ward from the service server 130 or the ward communications device 100. Also, the guardian communication device 120 may set a safety zone and may transmit information about the set safety zone to the service server 130. The guardian communications device 120 may be a guardian's mobile device in which the 3G specification is embedded. However, the guardian communications device 120 does not need to be limited to the mobile device in which the 3G specification is embedded. Obviously, the guardian communications device 120 may be a device having a wireless network function such as Wi-Fi.

The service server 130 receives a current location of the ward from the ward communications device 100 according to the location updating period which was determined based on the distance from the location of the ward to the boundary of a set safety zone, determines the current location of the ward within the safety zone and transmits the current location of the ward to the guardian communications device 120 or the home network 110. The service server 130 may be interfaced with an Internet Service Provider (ISP) that provides an Application Programming Interface (API), such as a map service, or may provide an interface for interfacing with a communications carrier.

The service server 130 includes an MMO/MNO Service Interface to be provided to the communications carrier that is located outside the home network, Service Aggregation in which mashup services for utilizing Open APIs provided by many service providers are realized, and an integrated management function, such as user management, device management, and network management functions.

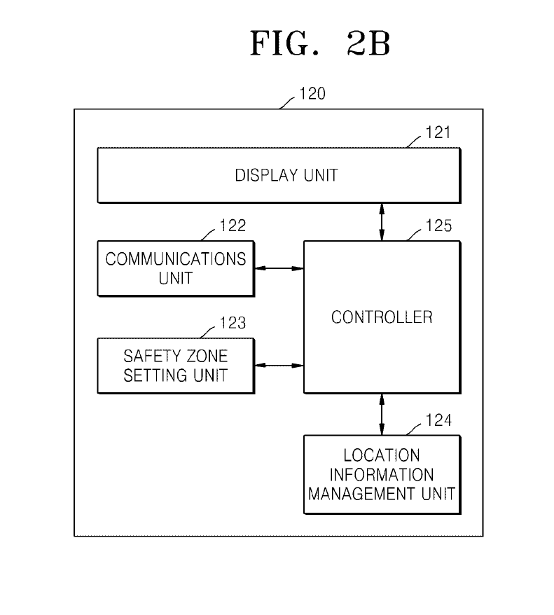

FIG. 2A is a schematic block diagram of the ward communications device 100 illustrated in FIG. 1. Referring to FIG. 2A, the ward communications device 100 includes a display unit 101, a communications unit 102, a location checking unit 103, a safety zone setting unit 104, a location information management unit 105, and a controller 106.

The display unit 101 displays data processed by the controller 106 to a user, i.e., the ward. Generally, most personal mobile communications devices include a display unit. Thus, although the display unit 101 is shown in the ward communications device 100 of FIG. 2A, it will be understood by one of ordinary skill in the art that the display unit 101 may not be an essential element for managing the location of the ward.

The communications unit 102 allows the ward communications device 100 to communicate with an external device via a communications network and may include a 3G module, for example. The communications unit 102 transmits the information about the location of the ward to the service server 130 or the guardian communications device 120 at a time corresponding to the determined location updating period.

The location checking unit 103 checks the location of the ward communications device 100. For example, the location checking unit 103 may check longitude, latitude or the like in which the ward communications device 100 is located. The ward communications device 100 may include a GPS module, for example.

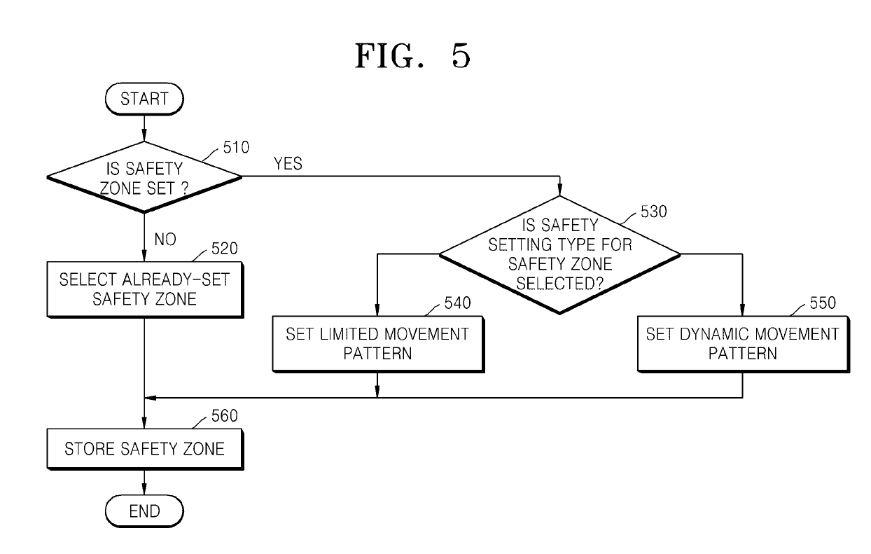

The safety zone setting unit 104 sets the safety zone. The safety zone may be set by the ward communications device 100 or the guardian communications device 120. If the safety zone is set by the ward communications device 100, information about the set safety zone is transmitted to the service server 130. If the safety zone is set by the guardian communications device 120, the information about the set safety zone may be transmitted to the service server 130 from the guardian communications device 120, and the information about the safety zone may be transmitted by the service server 130 to the ward communications device 100. A detailed method of setting the safety zone will be described later with reference to FIG. 5 in detail.

The location information management unit 105 manages the location of the ward, i.e., the location of the ward communications device 100. In detail, the location information management unit 105 may calculate the shortest distance from the current location of the ward to the boundary of the set safety zone and may obtain the time it takes for the ward to reach the boundary of the safety zone via the shortest distance, by using the calculated shortest distance and a movement speed of the ward. The time is managed according to the location updating period. When the time according to the location updating period has elapsed, the current location of the ward may be transmitted to the service server 130 or the guardian communications device 120. By determining the location updating period in this manner, the information about the location of the ward is provided for each location updating period so that the location of the ward can be efficiently monitored.

In more detail, a method of determining the ward location updating period will now be described with reference to FIG. 4.

FIG. 4 is a diagram for explaining a method of determining a period for updating a location of a ward, according to an embodiment.

Referring to FIG. 4, S is set to a safety zone. First, if the ward is located in a point A, a boundary point of the safety zone that forms the shortest distance from a current location A of the ward to a boundary of the safety zone, is SA. The shortest distance from the current location A to the boundary point SA of the safety zone may be calculated, and the time it takes for the ward to arrive at SA from the current location A may be known based on the shortest distance and a movement speed of the ward. If the time it takes for the ward to arrive at SA from the current location A is one hour, one hour is determined as the location updating period in the ward communications device 100. In other words, the time it takes for the ward to leave the set safety zone is one hour at the earliest. Thus, since there is a only a slight possibility that the ward may cross the boundary of the safety zone within one hour, the current location A of the ward is not monitored any further for the next one hour. If the location updating period is approaching its end, i.e., if one hour is about to elapse, the current location A of the ward is monitored again, and a new location updating period is determined for the location.

In the example of FIG. 4, it is assumed that the location updating period is determined as one hour when the ward is located at the point A. In this regard, the ward communications device 100 determines the location updating period as one hour, and the location of the ward is transmitted to the service server 130 or the guardian communications device 120 and then, a module for performing a communications function or a location checking function of the ward communications device 100 is turned off, and before the location updating period of one hour approaches its end, the module for performing a communications function or a location checking function of the ward communications device 100 is turned on so that the current location of the ward may be monitored. If, when the location updating period of one hour approaches its end, it is determined that the ward is located at a point B as a result of checking the current location of the ward, and the time according to the shortest distance from the location B of the ward to a safety zone boundary SB is calculated as 20 minutes, the time of 20 minutes is determined as a new location updating period. The location B of the ward is transmitted to the service server 130 or the guardian communications device 120 and then, the module for performing a communications function or a location checking function of the ward communications device 100 is turned off and then is turned on before the location updating period of 20 minutes elapses so that the current location B of the ward may be monitored. If, when the location updating period of 20 minutes approaches its end, it is determined that the ward is located at a point C as a result of checking the current location of the ward, and the time according to the shortest distance from the location C of the ward to a safety zone boundary SC is calculated as 30 minutes, the time of 30 minutes is determined as a new location updating period. In this manner, the time at which the ward is guaranteed to be located within the safety zone is determined as a location updating period, and the location of the ward is monitored for each location updating period so that the ward may be reliably monitored as being located within the safety zone, the location of the ward is not continuously checked but is checked only at a time according to the location updating period, location information about the ward is provided to a user, and battery consumption due to the use of the module for performing the communications function or the location checking function of the ward communications device 100 can be reduced.

The location updating period is calculated based on the movement speed of the ward in the corresponding location. Thus, if, after the location updating period is determined, the movement speed of the ward is significantly changed before the time according to the location updating period has elapsed, it may not be guaranteed that the ward will remain located within the safety zone during the location updating period that is first determined. For example, a location updating period calculated when the ward is located at the point A is one hour. After that, if the ward gets into a car for some reason, the ward may also leave the safety zone within the one hour. In consideration of this, if the ward communications device 100 monitors the movement speed of the ward and then the movement speed of the ward suddenly changes, the module for performing a communications function or a location checking function of the ward communications device 100 may be turned on so as to calculate the location of the ward again, and a new location updating period may be calculated from the location of the ward, and location information about the ward may be transmitted to the service server 130 or the guardian communications device 120.

The controller 106 controls the display unit 101, the communications unit 102, the location checking unit 103, the safety zone setting unit 104, and the location information management unit 105, so as to manage the location information about the ward. In detail, the controller 106 keeps track of the time according to the location updating period determined by the location information management unit 105, and if the time period is about to elapse, the controller 106 controls the location information management unit 105 to determine a new location updating period. Also, even if the time according to the location updating period is not about to elapse, if the movement speed of the ward is monitored and suddenly changes, the controller 106 controls the location information management unit 105 to determine a new location updating period or controls the communications unit 102 to transmit the location information about the ward to the service server 130 or the guardian communications device 120 via a communications network.

Although not shown in FIG. 2A, the ward communications device 100 may further include a sensor for detecting the movement speed of the ward or a timer or a counter for keeping track of the time according to the location updating period.

FIG. 2B is a schematic block diagram of the guardian communications device 120 illustrated in FIG. 1. Referring to FIG. 2B, the guardian communications device 120 includes a display unit 121, a communications unit 122, a safety zone setting unit 123, a location information management unit 124, and a controller 125.

The display unit 121 displays data processed by the controller 125 to the user, i.e., a guardian. Generally, most personal mobile communications devices include a display unit. In particular, the display unit 121 may display information about a current location of the ward, that has been received from the service server 130, to the guardian.

The communications unit 122 allows the guardian communications device 120 to communicate with an external device via a communications network and may include a 3G module or a Wi-Fi module. The communications unit 122 may receive the location information about the ward from the service server 130. Also, when the guardian himself/herself sets the safety zone of the ward, the communications unit 122 may transmit information about the set safety zone to the service server 130.

The safety zone setting unit 123 sets the safety zone. The safety zone may be set by using the ward communications device 100 or the guardian communications device 120. When the safety zone is set by using the guardian communications device 120, information about the set safety zone may be transmitted to the service server 130, and the service server 130 may also transmit the information about the safety zone to the ward communications device 100. A detailed method of setting the safety zone will be described in detail with reference to FIG. 5.

When receiving the information about the current location of the ward from the service server 130, the location information management unit 124 stores and manages the information. Also, when the user wants to check the current location of the ward in more detail, the location information management unit 124 connects to a web site that provides predetermined map services via the Internet so as to search the current location of the ward in more detail and provide information about the current location of the ward to the user.

The controller 125 controls the display unit 121, the communications unit 122, the safety zone setting unit 123, and the location information management unit 124. In detail, the controller 125 controls the communications unit 122 to transmit the information about the safety zone set by using the safety zone setting unit 123 to the service server 130. Also, the controller 125 controls the display unit 121 to display that the information about the current location of the ward has been received from the service server 130, to the guardian.

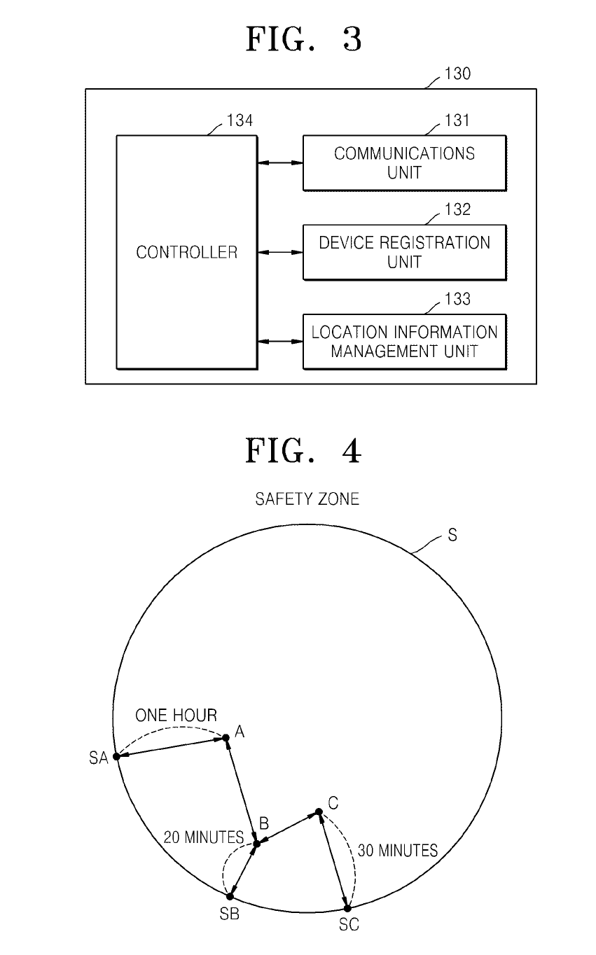

FIG. 3 is a schematic block diagram of the service server 130 illustrated in FIG. 1.

Referring to FIG. 3, the service server 130 includes a communications unit 131, a device registration unit 132, a location information management unit 133, and a controller 134.

The communications unit 131 transmits data processed by the controller 134 to the ward communications device 100, the home network 110, and the guardian communications device 120.

The device registration unit 132 registers profile information of the ward communications device 100, the home network 110, and the guardian communications device 120.

The location information management unit 133 receives the current location of the ward from the ward communications device 100 for each location updating period determined based on the distance from the current location of the ward to the boundary of the safety zone, determines the current location of the ward with respect to the safety zone and determines whether the current location of the ward has been transmitted to the guardian communications device 120 or the home network 110.

Whenever the current location of the ward is received from the ward communications device 100, the location information management unit 133 may transmit the current location of the ward to the guardian communications device 120. Alternatively, if the ward goes outside the safety zone, the location information management unit 133 may transmit the current location of the ward to the guardian communications device 120, and if the current location of the ward is not outside the safety zone, the location information management unit 133 may not transmit the current location of the ward to the guardian communications device 120.

The controller 134 controls the overall operation of the communications unit 131, the device registration unit 132, and the location information management unit 133.

FIG. 5 is a flowchart illustrating an operation of setting a safety zone, according to an embodiment.

The safety zone may be set by the ward communications device 100 or the guardian communications device 120. Alternatively, when the service server 130 provides a user interface for setting the safety zone, the guardian may also contact the service server 130 so as set the safety zone.

Referring to FIG. 5, it is determined whether to set a safety zone, in operation 510. If it is determined that the safety zone is not set but an already-set safety zone is selected, in operation 520, the selected safety zone is stored in operation 560, and the operation flow is terminated.

If it is determined that the safety zone is set, a type of a safety setting for the safety zone is selected in operation 530.

When the safety setting for the safety zone is set to a limited movement pattern in operation 540, an address-based movement point and radius information at the address-based movement point are input.

An efficient limited movement pattern is a directed movement pattern in which the range where the ward moves from a predetermined point to another point is defined. A user having the pattern described above may send a notification message to the guardian when the user moves from a predetermined point to another point and goes outside a predetermined area.

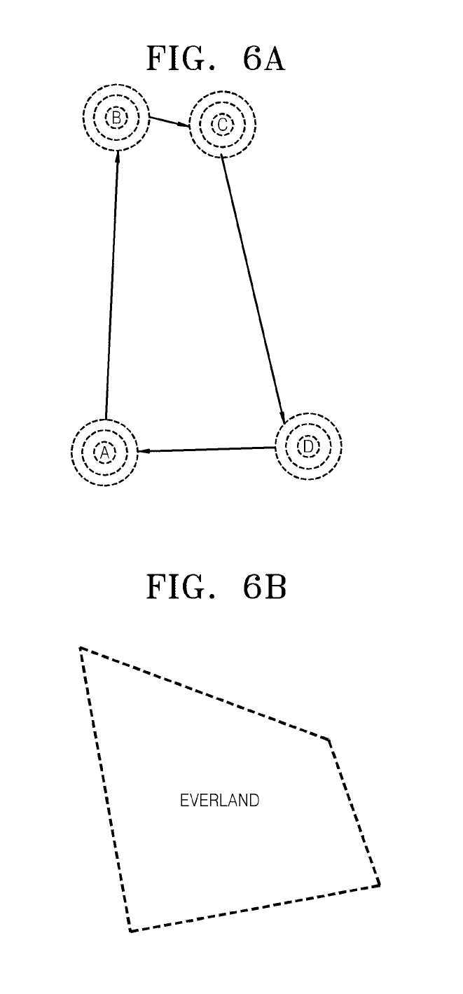

FIG. 6A illustrates an example of the limited movement pattern when the safety zone is set, and FIG. 6B illustrates an example of the dynamic movement pattern when the safety zone is set.

For example, referring to FIG. 6A, when the ward is a user having a life pattern in the order of home (A)—child care center (B)—piano institute (C)—English institute (D)—home (A), movement points are determined, and when an area including the movement points is set to a safety zone and the ward goes outside the safety zone, a notification message may be sent to the guardian so that the ward may be protected.

In the limited movement pattern, the user may input information about addresses of several buildings and radial direction distance information from the addresses, and the addresses and a radial area about each address may be the safety zone.

When the safety setting for the safety zone is set to a dynamic movement pattern in operation 550, the safety zone is set based on an address. As a method of dynamically setting the safety zone, a user having a random behavior pattern is assumed. For example, when a child and parents go to an amusement park together, the parents set a safety zone based on address information about the amusement park so as to more safely protect the child. Referring to FIG. 6B, the guardian may set the safety zone as an address of Everland.

Next, the set safety zone is stored in operation 560, and the operation flow is terminated.

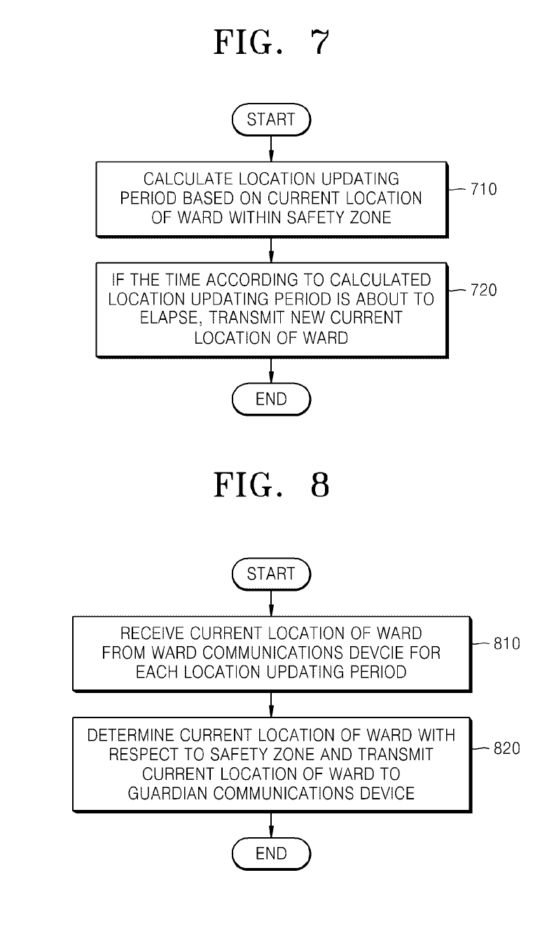

FIG. 7 is a flowchart illustrating a method of managing a location of a ward by using a ward communications device, according to an embodiment.

Referring to FIG. 7, a location updating period is calculated based on a current location of a ward within a safety zone in operation 710. In other words, by obtaining the shortest distance from the current location of the ward to a boundary of the safety zone and by using the shortest distance and a movement speed of the ward, the time it takes for the ward to arrive at the boundary of the safety zone via the shortest distance may be obtained. The time it takes for the ward to arrive at the boundary of the safety zone via the shortest distance may be determined as a location updating period. Also, the safety zone may be set by any one of the guardian communications device 120, the ward communications device 100, and the service server 130. If the safety zone is set by the communications device, information about the set safety zone may be transmitted to other communications devices or other service servers.

If the time according to the calculated location updating period is about to elapse, the current location of the ward is transmitted to the service server 130 or the guardian communications device 120 in operation 720.

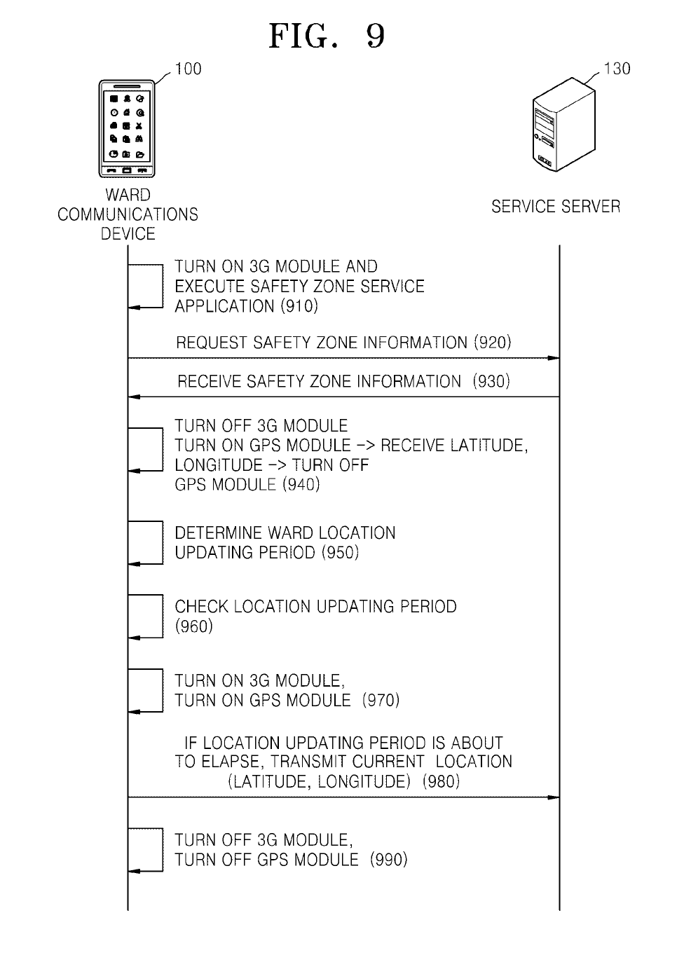

FIG. 8 is a flowchart illustrating a method of managing a location of a ward by using a service server, according to another embodiment.

Referring to FIG. 8, a current location of the ward is received from the ward communications device 100 for each location updating period in operation 810. The location updating period is calculated based on a distance from the current location of the ward to a boundary of a safety zone.

The current location of the ward with respect to the safety zone is determined, and the current location of the ward is transmitted to the guardian communications device 120 in operation 820. The time at which the current location of the ward is transmitted to the guardian communications device 120 may be determined in various ways. As one method, location information may be transmitted directly to the guardian communications device 120 without setting any condition whenever ward location information is received from the ward communications device 100. Alternatively, when the current location of the ward is within the safety zone, the current location of the ward is not transmitted to the guardian communications device 120, and when the current location of the ward is outside the safety zone, the current location of the ward may be transmitted to the guardian communications device 120.

FIG. 9 illustrates an example of an operation of managing a location of a ward between the ward communications device 100 and the service server 130.

Referring to FIG. 9, the ward communications device 100 turns on a 3G module and executes a safety zone service application in operation 910.

The ward communications device 100 requests the service server 130 for safety zone information in operation 920 and receives the safety zone information from the service server 130 in operation 930.

Next, the ward communications device 100 turns off the 3G module and turns on a GPS module so as to receive the location of the ward, i.e., latitude and longitude information, and then turns off the GPS module in operation 940.

Next, the ward communications device 100 determines a ward location updating period in operation 950. A method of determining the ward location updating period may be based on the method described with reference to FIGS. 2 and 4.

The ward communications device 100 checks the location updating period in operation 960. If the time according to the location updating period is about to elapse, the 3G module and the GPS module are turned on in operation 970. Next, the ward communications device 100 transmits the current location (latitude and longitude) of the ward to the service server 980 if the time according to the location updating period is about to elapse.

Next, the ward communications device 100 turns off the 3G module and the GPS module in operation 990.

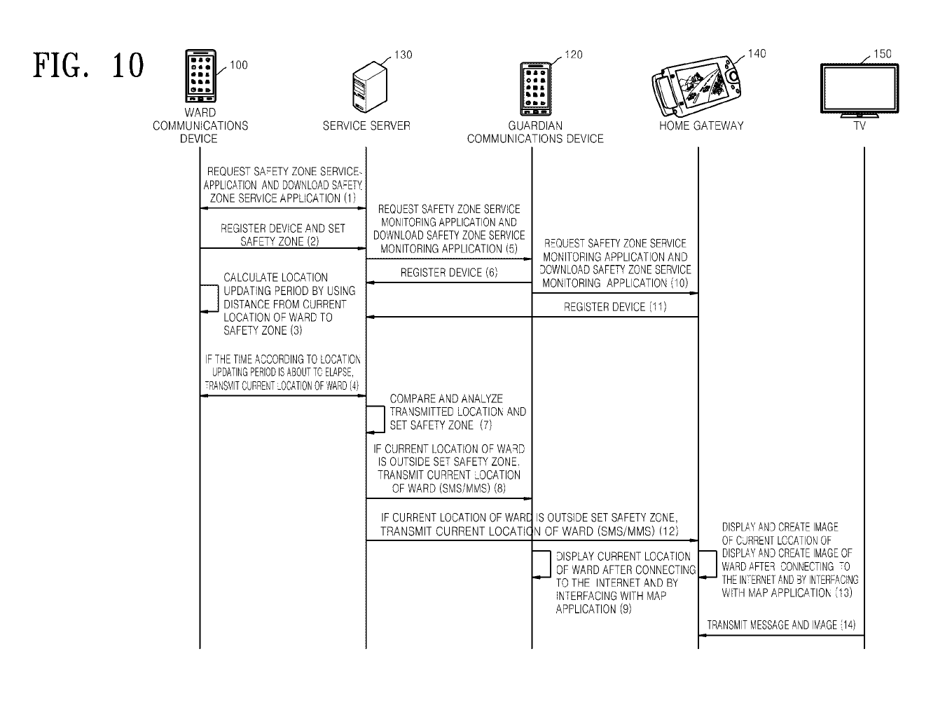

FIG. 10 illustrates an example of an operation of managing a location of a ward between the ward communications device 100, the service server 130, the guardian communications device 120, and a home gateway 140.

Referring to FIG. 10, an operation to be performed between the ward communications device 100 and the service server 130 is similar to the operation illustrated in FIG. 9. First, the ward communications device 100 requests the service server 130 for a safety zone service application and downloads and installs the safety zone service application in operation 1. Next, the ward communications device 100 is registered as a device in the service server 130 and sets a safety zone in operation 2.

The ward communications device 100 calculates a location updating period by using a distance from a current location of the ward to the safety zone in operation 3, and if the time according to the location updating period is about to elapse, the current location of the ward is transmitted to the service server 130 in operation 4.

An operation to be performed between the service server 130 and the guardian communications device 120 is performed as follows.

The guardian communications device 120 requests the service server 130 for a safety zone service monitoring application and downloads and installs the safety zone service monitoring application in operation 5.

The guardian communications device 120 is registered as a device in the service server 130 in operation 6.

When the service server 130 receives the current location of the ward from the ward communications device 100 for each location updating period, the current location of the ward and the safety zone are compared with each other and are analyzed in operation 7. When the current location of the ward is outside the set safety zone, the service server 130 transmits the current location to the ward communications device 120 by using a multimedia messaging system (MMS) or a short message service (SMS) in operation 8.

When the guardian communications device 120 receives the current location of the ward from the service server 130, the current location of the ward is displayed after connecting to the Internet and by interfacing with a map application in operation 9 so that the current location of the ward is checked.

An operation to be performed between the service server 130 and the home gateway 140 is also similar to the operation performed between the service server 130 and the guardian communications device 120.

The home gateway 140 requests the service server 130 for a safety zone service monitoring application and downloads and installs the safety zone service monitoring application in operation 10.

The home gateway 140 is registered as a device in the service server 130 in operation 11.

When the service server 130 receives the current location of the ward from the ward communications device 100 for each location updating period, the current location of the ward and the safety zone are compared with each other and are analyzed in operation 7. When the current location of the ward is outside the set safety zone, the service server 130 transmits the current location to the home gateway 140 by using an MMS or an SMS in operation 12.

When the home gateway 140 receives the current location of the ward from the service server 130, the current location of the ward is displayed after connecting to the Internet and by interfacing with a map application in operation 13 so that the current location of the ward may be checked.

In addition, the home gateway 140 may transmit a message related to the current location of the ward or an image in which the current location of the ward is displayed, to a television (TV) 150 connected to the home network in operation 14.

As described above, a location of a ward may be easily updated with a message at minimum cost when the ward such as a child or an elderly person needs to be protected, and a simple and easy guide service may be provided to targets, such as children or elderly people, who may have difficulty manipulating a communications device, by using a remote control.

According to an aspect of an exemplary embodiment, the current location of the ward is not continuously monitored but is monitored for each location updating period based on a distance from the current location of the ward to a boundary of a safety zone so that battery consumption required for monitoring the current location of the ward can be saved. In addition, since the current location of the ward is transmitted for each location updating period, costs required for transmitting a message can be reduced. In addition, since the location updating period in which the current location of the ward is monitored, is calculated based on a distance from the current location of the ward to the boundary of the safety zone, reliability for monitoring the ward located within the safety zone can be guaranteed.

The aspects of the exemplary embodiments can also be embodied as computer readable codes on a non-transitory computer readable recording medium. The non-transitory computer readable recording medium is any data storage device that can store data which can be thereafter read by a computer system. Examples of the non-transitory computer readable recording medium include read-only memory (ROM), random-access memory (RAM), CD-ROMs, magnetic tapes, floppy disks, optical data storage devices, etc. The non-transitory computer readable recording medium can also be distributed over network coupled computer systems so that the computer readable code is stored and executed in a distributed fashion. Also, functional programs, codes, and code segments for accomplishing the present inventive concept can be easily construed by programmers of ordinary skill in the art to which the aspects of the exemplary embodiments pertain.

Although a few exemplary embodiments have been shown and described, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the inventive concept is defined not by the detailed description of the exemplary embodiments but by the appended claims, and all differences within the scope will be construed as being included in the present inventive concept.

1. A method of managing a location of a ward, the method comprising:
determining a ward location updating period based on a current location of the ward within a safety zone; and
transmitting a new relocated current location of the ward when the determined ward location updating period elapses.

2. The method of claim 1, wherein the determining of the ward location updating period comprises calculating a shortest distance from the current location of the ward within the safety zone to a boundary of the safety zone and determining a time it takes for the ward to reach the boundary of the safety zone by using the calculated shortest distance and a movement speed of the ward, as the ward location updating period.

3. The method of claim 1, further comprising setting the safety zone.

4. The method of claim 3, wherein the setting of the safety zone comprises setting the safety zone based on an address or setting the safety zone by using an address and a movement radius.

5. A method of managing a location of a ward, the method comprising:
receiving the location of the ward from a ward communications device at each ward location updating period which was determined based on the location of the ward within a safety zone; and
determining a current location of the ward with respect to the safety zone and transmitting the current location of the ward to a guardian communications device according to the determination.

6. The method of claim 5, wherein the transmitting of the current location of the ward comprises, transmitting the current location of the ward to the guardian communications device when the ward is outside the safety zone, and not transmitting the current location of the ward to the guardian communications device when the ward is not outside of the safety zone.

7. The method of claim 5, further comprising receiving information for setting the safety zone from the guardian communications device or the ward communications device.

8. An apparatus for managing a location of a ward, the apparatus comprising:
a location information management unit which determines a ward location updating period based on the location of the ward within a safety zone and if the determined ward location updating period is about to elapse, checking a current location of the ward when the determined ward location updating period elapses; and
a communications unit which transmits the current location of the ward.

9. The apparatus of claim 8, wherein the location information management unit calculates a shortest distance from the location of the ward to a boundary of the safety zone and determines a time it takes for the ward to reach the boundary of the safety zone by using the calculated shortest distance and a movement speed of the ward, as the ward location updating period.

10. The apparatus of claim 8, further comprising a safety zone setting unit setting the safety zone.

11. The apparatus of claim 10, wherein the safety zone setting unit sets the safety zone based on an address or sets the safety zone by using an address and a movement radius.

12. An apparatus for managing a location of a ward, the apparatus comprising:
a communications unit which receives the location of the ward from a ward communications device at every ward location updating period which is determined based on the location of the ward within a safety zone; and
a location information management unit which determines a current location of the ward with respect to the safety zone and which determines whether the current location of the ward is transmitted to a guardian communications device.

13. The apparatus of claim 12, wherein the location information management unit determines whether the current location of the ward has been transmitted to the guardian communications device if the current location of the ward is outside the safety zone and determines whether the current location of the ward has not transmitted to the guardian communications device if the current location of the ward is not outside the safety zone.

14. The apparatus of claim 12, wherein the communications unit receives information for setting the safety zone from the guardian communications device or the ward communications device.

15-18. (canceled)
